(19) United States
(12) Patent Application Publication
(10) Pub. No.: US 2013/0008355 A1
(43) Pub. Date: Jan. 10, 2013

(54) LITHIUM-BASED CONCRETE ADMIXTURES FOR CONTROLLING ALKALI-SILICA REACTIONS WITH ENHANCED SET-TIME CONTROL AND PROCESSES FOR MAKING THE SAME

(75) Inventor: David B. Stokes, Shelby, NC (US)

(73) Assignee: FMC Corporation

(21) Appl. No.: 13/541,074

(22) Filed: Jul. 3, 2012

Related U.S. Application Data
(60) Provisional application No. 61/504,758, filed on Jul. 6, 2011.

(51) Int. Cl. C04B 24/12

(52) U.S. Cl. 106/810; 106/638

(57) ABSTRACT

A process for making concrete which is stabilized against alkali-silica reactivity (ASR) is provided. The process includes incorporating into the concrete mixture a concrete admixture mixture comprising water, first lithium-containing materials in an amount sufficient to control ASR, and second lithium-containing materials in an amount sufficient for controlling set time, and optionally mineral admixtures and other chemical admixtures for property enhancements exclusive of ASR mitigation and/or set time control, to form the concrete. An admixture for stabilizing concrete against ASR is also provided.

### CROSS-REFERENCE TO RELATED APPLICATIONS

This application claims the benefit of and incorporates herein by reference in its entirety, the following United States Provisional Application: U.S. Provisional Application No. 61/504,758, filed Jul. 6, 2011.

### FIELD OF THE INVENTION

This invention relates generally to lithium-based concrete admixtures and processes for producing the same, and more particularly lithium-based admixtures for controlling alkali-silica reaction in concrete which includes the cement as a component.

### BACKGROUND OF THE INVENTION

Concrete is a conglomerate of aggregate (such as gravel, sand, and/or crushed stone), water, and hydraulic cement (such as portland cement), as well as other components and/or additives. Concrete is generally fluidic when it is first made, enabling it to be poured or placed into shapes, and then later hardens or sets, and is never again fluidic, in the general sense. Typically, moisture present in normal concrete is basic (that is, has a high pH). Alkali materials can be supplied by the cement, aggregate, additives, and even from the environment in which the hardened concrete exists (such as salts placed on concrete to melt ice).

Silica compounds are typically found in the aggregate components of concrete. Silica which is present in aggregates used to make concrete and mortars is subject to attack and dissolution by hydroxide ions present in basic solutions. Generally, the higher the pH (i.e., the more basic the solution), the faster the attack.

Different forms of silica show varying degrees of susceptibility to this dissolution. If there is sufficient alkali metal ion also present in this solution (such as sodium or potassium ions), the alkali metal ions can react with the dissolved silica and form an alkali-silica gel. Under certain conditions, the resultant alkali-silica gel can absorb water and swell. The swelling can exert pressures greater than the tensile strength of the concrete and thus cause the concrete to swell and crack. This process (hydroxide attack of silica, followed by reaction with alkali such as sodium and potassium) is referred to generally in the art as an “alkali-silica reaction” or “ASR”.

ASR has caused the failure of concrete structures, although rarely. Further, ASR can weaken the ability of concrete to withstand other forms of attack. For example, concrete that is cracked due to this process can permit a greater degree of saturation and is therefore much more susceptible to damage as a result of “freeze-thaw” cycles. Similarly, cracks in the surfaces of steel reinforced concrete can compromise the ability of the concrete to keep out salts when subjected to deicers, thus allowing corrosion of the steel it was designed to protect.

Various solutions have been proposed such as use of a low alkali cement, use of non-reactive aggregate, use of appropriate levels of a suitable pozzalan, and the use of lithium-containing materials. All of these, particularly the latter, are described in U.S. Pat. No. 5,755,876, the disclosure of which is incorporated herein by reference in its entirety.

The main lithium-based concrete admixture used at present in the marketplace to control ASR is comprised of an aqueous solution of lithium nitrate in water. This form of lithium-based admixture has obtained predominance in the marketplace because it is the most effective lithium compound for ASR suppression based on the lithium ion content, and has otherwise the least effects on plastic and hardened properties of the concrete manufactured which incorporates such admixtures. One potential problem with the use of lithium-nitrate-based admixture is that such admixtures tend to accelerate set times of portland cement to greater or lesser degrees, depending on the cement chemistry among other things, and mainly because of the inclusion of the nitrate anion in the admixture, which is otherwise advantageous to controlling deleterious expansions due to ASR. Such acceleration may result in a decrease in long term strength gain of concrete manufactured with such an admixture, as well as difficulties in placement of the concrete in actual use. Thus there is a need for concrete compositions having controlled ASR while having greater control of the set time.

### SUMMARY OF THE INVENTION

A process for making concrete which is stabilized against ASR is provided. The process includes the incorporation into the concrete of a lithium-based concrete admixture in an amount sufficient to control ASR. Compounds are incorporated into the admixture to modify the set time of the concrete in a controlled manner to enhance the placement and enhance the subsequent strength development of the concrete. A lithium-based admixture which stabilizes against ASR and provides a controllable set time is also provided.

### BRIEF DESCRIPTION OF THE DRAWINGS

Some of the features and advantages of the invention having been described, others will become apparent from the detailed description which follows, and from the accompanying drawings, in which:

FIG. 1 is a graph of Initial Time of Set versus % Molar Fraction of the second lithium-containing compound in a concrete admixture composition.

FIG. 2 is a graph of isothermal calorimetry results showing the effect on the hydration time for a portland cement (alone) and with a first lithium-containing compound (lithium nitrate) incorporating increasing amounts of a second lithium-containing compound (lithium citrate).

### DETAILED DESCRIPTION OF THE INVENTION

The foregoing and other aspects of the present invention will now be described in more detail with respect to the description and methodologies provided herein. It should be appreciated that the invention can be embodied in different forms and should not be construed as limited to the embodiments set forth herein. Rather, these embodiments are provided so that this disclosure will be thorough and complete, and will fully convey the scope of the invention to those skilled in the art.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise. Also, as used herein, “and/or” refers to and encompasses any and all possible combinations of one or more of the associated listed items. Furthermore, the term “about,” as used herein when referring to a measurable value such as an amount of a compound, dose, time, temperature, and the like, is meant to encompass variations of 20%, 10%, 5%, 1%, 0.5%, or even 0.1% of the specified amount.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Unless otherwise defined, all terms, including technical and scientific terms used in the description, have the same meaning as commonly understood by one of ordinary skill in the art to which this invention belongs.

The term “consists essentially of” (and grammatical variants), as applied to the methods in this invention, means the methods or compositions can contain additional steps as long as the additional steps or components do not materially alter the basic and novel characteristic(s) of the present invention.

The term “consisting of” excludes any additional step that is not specified in the claim.

Unless the context indicates otherwise, it is specifically intended that the various features of the invention described herein can be used in any combination.

Moreover, the present invention also contemplates that in some embodiments of the invention, any feature or combination of features set forth herein can be excluded or omitted.

All patents, patent applications and publications referred to herein are incorporated by reference in their entirety. In case of a conflict in terminology, the present specification is controlling.

An admixture is provided that stabilizes a concrete mixture from ASR and has a controlled set time. The term “controlled set time” as applied to the present invention relates to the set time being adjusted by selection of the components of the cement mixture. In one embodiment, the set time is controlled so as to provide a longer or higher set time in that often concrete having some lithium-containing materials sets too fast.

The concrete mixture comprises cement, aggregates, water, and optionally other chemical and mineral admixtures for enhancement of various concrete properties, and a lithium-containing admixture containing a first lithium compound in an amount sufficient to control ASR and a second lithium-containing compound in an amount sufficient to control set time. The process for making concrete includes incorporating the set-enhancing lithium-based concrete admixture into the concrete mixture during the manufacture of the concrete.

In the present invention, the first and second lithium-containing materials are added as an admixture in the process of combining all of the materials used to manufacture the concrete.

As used herein, the terms “cement” and “cement starting materials” refer to, but is not limited to, hydraulic and alite cements, such as Portland cement; blended cements, such as Portland cement blended with fly ash, blast-furnace slag, pozzolans, and the like, and mixtures thereof; masonry cement; oil well cement; natural cement; alumina cement; expansive cements, and the like, and mixtures thereof.

Exemplary first lithium-containing materials used to control ASR include, but are not limited to, refined lithium products such as lithium salts (for example, lithium carbonate, lithium hydroxide monohydrate, lithium nitrate, lithium fluoride, lithium chloride, lithium acetate, and the like, and mixtures thereof). Other lithium sources include lithium bearing ores and lithium ore concentrates such as lithium aluminum silicates, such as spodumene (Li₂O.Al₂O₃.4SiO₂), petalite (Li₂O.Al₂O₃.8SiO₂), eucryptite (Li₂O.Al₂O₃.2SiO₂), montrebrasite, lepidolite, lithium-aluminate phosphate ores, such as amblygonite (LiF.AlPO₄), lithium-bearing clays, and the like and mixtures thereof. As the skilled artisan will appreciate, the term “lithium bearing ore concentrate” refers to lithium bearing ores which have been treated (beneficiated) to concentrate the lithium bearing mineral. For ease of reference, as used herein the term “lithium bearing ores” refers to both beneficiated and non-beneficiated lithium bearing ores.

Exemplary second lithium-containing materials used to control set times include, but are not limited to, lithium citrate, lithium gluconate, lithium borate, lithium carbonate, lithium acetate, lithium salts of carboxylic acids and various other lithium salts, such as listed above related to the first lithium-containing compounds. It is recognized that the salts listed as being suitable first lithium-containing materials may also be used as a second lithium-containing material to control set time depending on the specific cement starting materials and the combination of first and second lithium-containing materials. It is noted that the second lithium-containing material may be used to control the amount of water.

The concrete admixture can be in liquid aqueous form or can be a dried powder without water. In one embodiment with water present, the first lithium-containing compound is about 1 to 50 percent by weight of the concrete admixture and the second lithium-containing compound is about 0.1 to 10 percent by weight of the concrete admixture. When water is not part of the concrete admixture formulation, the first lithium-containing compound is about 10 to 99.9 percent by weight of the concrete admixture and the second lithium-containing compound is about 0.1 to 40 percent by weight of the concrete admixture.

With respect to the overall concrete mixture, the amount of the first lithium-containing compound is from about 0.1 to 1 percent by weight of the concrete mixture. The amount of the second lithium-containing material may be from about 0.00025 to 0.0125 percent by weight of the concrete mixture. It is recognized that small amounts, for example, about 0.00025 to 0.0125 percent by weight of the concrete mixture of non-lithium alkali salts or other non-lithium compounds such as, for example, non-lithium salts of hydroxycarboxylic acids, compound carbohydrates, 2-phosphonobutane-1,2,4-tricarboxylic acid, and [nitrilotris(methylene)]tris-phosphonic acid may be added to further facilitate controlling set times so long as the amount of such alkali salts is not substantially detrimental to the ASR affects provided by the first lithium-containing compounds.

The amount of the lithium-containing materials depends on the reactivity of the aggregate and the alkali loading of the overall mixture, primarily from the cement. The standard amount or “dose” is a 0.74 molar ratio of lithium to potassium and sodium. Different amounts from this standard dose of 0.74 molar ratio are referred to as a percentage of the standard dose. Thus in the present invention, the lithium-containing materials are added to the concrete mixture in an amount to yield between about 50 to 150 percent of about a 0.74 molar ratio of lithium ion from the admixture to sodium plus potassium ion from the cement used to make the concrete.

The concrete compositions of the present invention generally include the cement mixture, aggregate, and water. The cement is present in the fluid concrete mixture in an amount between about 5 to 50 percent by weight of the concrete mixture.

Aggregates can include, but are not limited to, natural and crushed quarried aggregate, sand, recycled concrete aggregate, glass, and the like, as well as mixtures thereof. Aggregate is present in the fluid concrete mixture in an amount between about 50 to 95 percent by weight of the concrete mixture.

The fluid concrete mixture also includes water, in an amount ranging from about 2 to 30 percent by weight of the concrete mixture. The fluid concrete mixture also can include other materials as known in the art for imparting various properties to concrete, including, but not limited to, air-entraining admixtures, water reducing admixtures, accelerating admixtures, pozzolans, such as, but not limited to, fly ash, metakaolin, and silica fume, and the like. These mineral and chemical admixtures can be present in conventional amounts so long as they do not adversely affect ASR.

Although reference has been made to the components of concrete, it will be appreciated that the present invention also includes mortar compositions, which generally are similar in composition to concrete, except that mortar is typically made with sand as the sole aggregate, in contrast to concrete which includes larger aggregates. Sand in this sense is aggregate of about ⅜″ and smaller diameter.

The present invention will be further illustrated by the following non-limiting examples.

### EXAMPLE

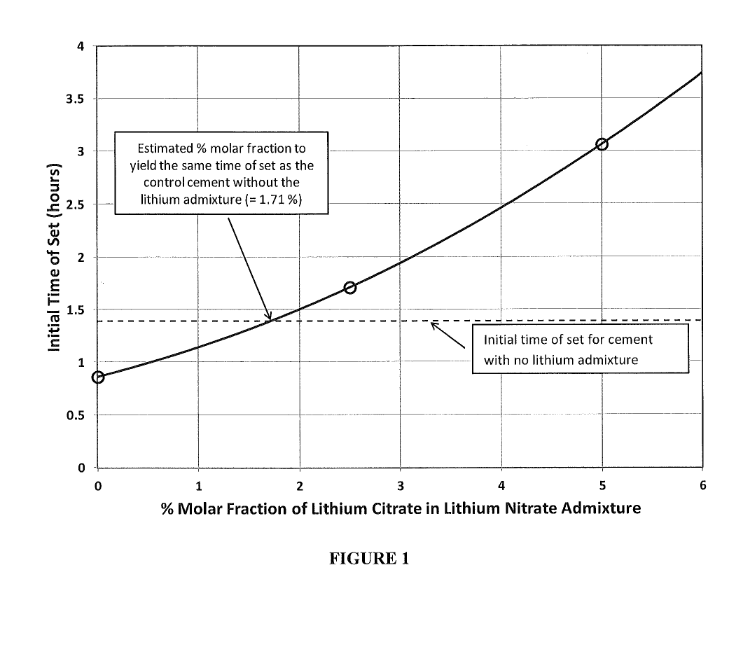

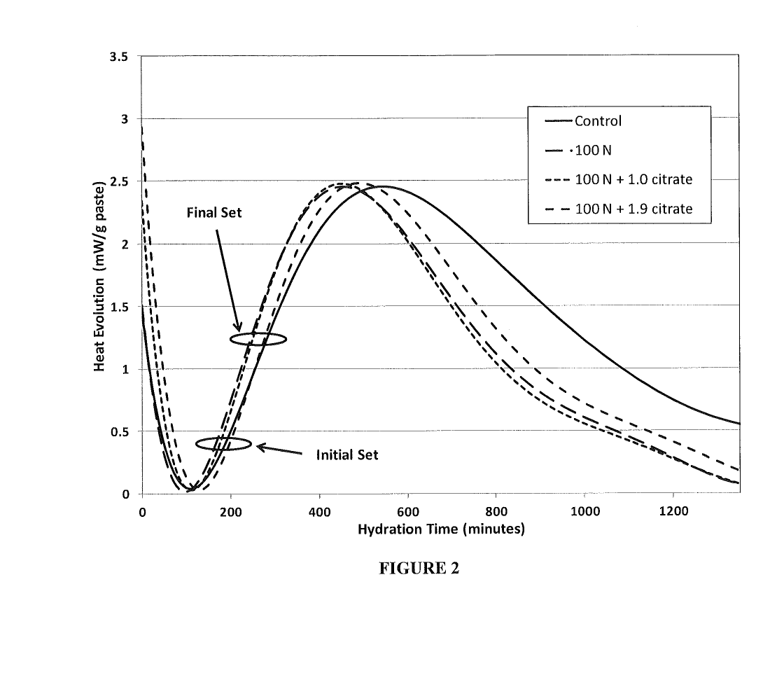

Results are shown in FIGS. 1 and 2. The results were obtained by testing mortars containing admixture compositions with varying molar fractions of a cement and an admixture comprising a first lithium-containing compound (lithium nitrate) with increasing amounts of a second lithium-containing compound (lithium citrate).

The work illustrated in FIG. 1 was performed according to ASTM C 191, Standard Test Methods for Time of Setting of Hydraulic Cement by Vicat Needle. With the straight lithium nitrate admixture, the set time is accelerated (shortened) by approximately one-half hour compared to the control cement used in this demonstration. Increasing amounts of the second lithium-containing compound lengthen the set time. Interpolation of this data demonstrates that using 1.71% molar fraction of lithium citrate to lithium nitrate would yield an admixture with no noticeable effect on set time, that is, the set time would be the same as the control cement without any lithium admixture.

FIG. 2 shows isothermal calorimetry results of a portland cement paste and lithium nitrate admixture with increasing amounts of lithium citrate. As more citrate is incorporated into the admixture, the main hydration peak can be seen to be delayed relative to the time it occurs with lithium nitrate alone, corroborating the trend in set times shown in FIG. 1.

Having thus described certain embodiments of the present invention, it is to be understood that the invention defined by the appended claims is not to be limited by particular details set forth in the above description as many apparent variations thereof are possible without departing from the spirit or scope thereof as hereinafter claimed.

What is claimed:

1. A process for making a concrete mixture which is stabilized against alkali-silica reactivity (ASR), the process comprises incorporating into the concrete mixture a concrete admixture comprising first lithium-containing materials in an amount sufficient to control ASR, second lithium-containing materials in an amount sufficient for controlling set time, and optionally, water, and optionally mineral admixtures and chemical admixtures for property enhancements exclusive of ASR mitigation and/or set time control, to form the concrete.

2. The process of claim 1, wherein said first lithium-containing material comprises lithium salt.

3. The process of claim 2, wherein said lithium salt is selected from the group consisting of lithium carbonate, lithium hydroxide monohydrate, lithium nitrate, lithium fluoride, lithium chloride, lithium citrate, and mixtures thereof.

4. The process of claim 1 wherein the second lithium-containing material is selected from the group consisting of lithium citrate, lithium gluconate, lithium borate, lithium acetate, and lithium nitrate, and mixtures thereof.

5. A concrete admixture which stabilizes the admixture against alkali-silica reactivity (ASR) and possesses an increased set time to the admixture, the admixture comprising first lithium-containing materials in an amount sufficient to control ASR and second lithium-containing materials in an amount sufficient for controlling set time.

6. The concrete admixture of claim 5, wherein the concrete admixture is in aqueous form and wherein the amount of the first lithium-containing material is from about 5 to 50 percent by weight of the concrete admixture, and the amount of the second lithium-containing material is from about 0.1 to 10 percent by weight of the concrete admixture.

7. The concrete admixture of claim 5, wherein the concrete admixture is formulated with no water and wherein the amount of the first lithium-containing material is from about 10 to 99.9 percent by weight of the concrete admixture and the amount of the second lithium-containing material is from about 0.1 to 40 percent by weight of the concrete admixture.

8. The concrete admixture of claim 5, wherein the first lithium-containing material is selected from the group consisting of lithium carbonate, lithium hydroxide monohydrate, lithium nitrate, lithium fluoride, lithium chloride, and mixtures thereof and wherein the second lithium-containing material is selected from the group consisting of lithium citrate, lithium gluconate, lithium borate, and lithium acetate, and mixtures thereof.

9. The concrete admixture of claim 6, wherein the first lithium-containing material is selected from the group consisting of lithium carbonate, lithium hydroxide monohydrate, lithium nitrate, lithium fluoride, lithium chloride, and mixtures thereof and wherein the second lithium-containing material is selected from the group consisting of lithium citrate, lithium gluconate, lithium borate, and lithium acetate, and mixtures thereof.

10. The concrete admixture of claim 7, wherein the first lithium-containing material is selected from the group consisting of lithium carbonate, lithium hydroxide monohydrate, lithium nitrate, lithium fluoride, lithium chloride, and mixtures thereof and wherein the second lithium-containing material is selected from the group consisting of lithium citrate, lithium gluconate, lithium borate, and lithium acetate, and mixtures thereof.

11. A concrete comprising the concrete admixture of claim 5, cement, aggregate, and water.

12. A concrete comprising the concrete admixture of claim 6, cement and aggregate.

13. A concrete comprising the concrete admixture of claim 7, cement, aggregate, and water.
